(19) United States
(12) Patent Application Publication
(10) Pub. No.: US 2008/0069180 A1
(43) Pub. Date: Mar. 20, 2008

(54) Fiber optic temperature sensing system using a hemispherical phosphor

(76) Inventor: Derek Djeu, Tampa, FL (US)

Correspondence Address: Derek Djeu, 15817 Sanctuary Dr., Tampa, FL, 33647, US

(21) Appl. No.: 11/900,736

(22) Filed: Sep. 13, 2007

Related U.S. Application Data
(60) Provisional application No. 60/845,820, filed on Sep. 19, 2006.

(51) Int. Cl. G01K 11/00

(52) U.S. Cl. 374/161

(57) ABSTRACT

The present invention provides a fluorescence-based fiber optic temperature sensing system employing a probe with a hemispherically shaped phosphor attached thereto. The probe set forth herein not only produces fluorescence efficiently, but is also easily fabricated.

### REFERENCE TO RELATED APPLICATION

This application claims the benefit of U.S. Provisional Patent Application No. 60/845,820 filed on Sep. 19, 2006.

### FIELD OF INVENTION

This invention relates generally to a means of temperature sensing and, more particularly, a means of temperature sensing using an optical fiber with a phosphor attached to its end.

### BACKGROUND OF INVENTION

Fiber optic temperature sensors based on the fluorescence from phosphors are widely used in electrically or RF/microwave noisy environments. Typically, excitation light is guided by the optical fiber to the phosphor sensing element. The temperature of the latter is manifested through its fluorescent properties, such as changes in its emission spectrum or decay time. Once the fluorescence signal is guided back by the fiber and processed, a correlation with the temperature can be made.

The attachment of the phosphor sensing tip to the optical fiber can take many forms. An early proposal was to use an end cap to cover the phosphor and keep it at the end of the optical fiber (U.S. Pat. No. 4,592,664). This construction, however, is not very stable mechanically. Another approach is to use a lead fiber made from essentially the same crystalline material as the phosphor and grow the tip directly onto the fiber (U.S. Pat. No. 6,045,259). While this latter phosphor attachment method is mechanically robust, its manufacture is very time-intensive.

Additionally, the length of the phosphor in the direction of the fiber axis is generally kept as short as possible to achieve both a high spatial resolution and a fast thermal response. This short length often prevents the efficient utilization of the excitation light if the absorption in the phosphor is not strong enough. At the same time, the phosphor typically ends in a flat surface. That is, it has a substantially cylindrical shape. In such a configuration, the fluorescence emitted in the forward direction (i.e., in the same general direction as the incident excitation light) is mostly lost.

What is needed in the art is a probe which is simultaneously robust and easy to fabricate, and which produces fluorescence efficiently.

### SUMMARY OF INVENTION

This invention provides a fiber optic temperature sensing system employing a probe with a substantially hemispherical phosphor. With such a construction, some of the excitation light rays experience multiple total internal reflections within the phosphor, which leads to increased absorption. Furthermore, some of the fluorescence which would otherwise exit the phosphor through its front surface will be directed back into the fiber, also as a result of total internal reflection. Both of these effects lead to an enhanced fluorescence signal. A hemispherically shaped phosphor also facilitates the creation of a robust bond between the phosphor and the fiber.

The fabrication of such a probe consists of two steps. First, the hemispherical phosphor is attached to the polished end of a lead fiber using either a wetting agent or an adhesive with good transparency. The bonding achieved in this first step needs only to be strong and lasting enough so that the phosphor does not fall off in the second step, which consists of dipping the assembled phosphor and fiber in a second adhesive to provide a coating with permanent bonding ability surrounding the hemispherical phosphor and the end portion of the lead fiber. This second step may be repeated to create a more robust structure if necessary. Preferably, the second adhesive should be diffusively reflective when fully cured to enhance both the absorption of the excitation light and the collection of the fluorescence.

To complete the temperature sensing system, the fiber optic probe with the hemispherically shaped phosphor attached to it is connected, either directly or through a fiber optic patch cord, to an optoelectronic controller-processor. The latter contains an optical excitation source, a detector, a digital signal processor, and their associated electronic and optical components. It is also possible to have a single signal processor controlling multiple light sources and detectors coupling to several probes. The controller-processor may be fitted with any combination of digital and analog outputs and digital displays.

### BRIEF DESCRIPTION OF DRAWINGS

FIG. 1 illustrates total internal reflections of an excitation light ray within a hemispherically shaped phosphor.

FIG. 2 illustrates total internal reflection of a fluorescence light ray emitted from a point within a hemispherically shaped phosphor.

FIG. 3 illustrates the reflection of a ray of either excitation light or fluorescence induced within the phosphor as a result of multiple scatterings within an adhesive coating.

FIG. 4 is a cross-sectional view of a rigid probe protected by a ceramic tube.

FIG. 5 is a schematic of a temperature sensing system incorporating a probe with a hemispherically shaped phosphor.

### DETAILED DESCRIPTION OF THE PREFERRED EMBODIMENTS

A preferred way of fabricating the hemispherical phosphor is to start with a microsphere having a radius approximately equal to that of the fiber to which it is to be attached. It is then polished until approximately half is left. It should be clear to those versed in the art that hemispherical phosphors with the same radius can be fabricated in batches in this fashion.

With the phosphor lying on a flat surface with its curved side facing up, it can be picked up by a suction capillary tube. The tube is then oriented so that the end holding the phosphor is pointing up, and the vacuum is turned off. Next the polished end of an optical fiber is dipped in a liquid, held with the wetted end facing down, centered directly above the flat side of the phosphor, and lowered to make contact with the phosphor. Provided the liquid wets both the fiber and the phosphor, the phosphor will be held to the fiber at least temporarily. This bond needs only to be strong enough so that the phosphor does not fall off in the next step of fabricating the probe. The liquid may be a volatile one, such as an alcohol, which will eventually dissipate through evaporation. Alternatively, it may be an adhesive, to be referred to as first adhesive. In the latter case, it should be substantially transparent to both the excitation wavelength and the fluorescence wavelength.

The final step of fabricating the probe consists of dipping the phosphor and a short length of the fiber near the end in a second adhesive which is capable of creating a permanent bond between the fiber and the phosphor. This second adhesive preferably should have, upon curing, a refractive index which is significantly lower than that of the phosphor. For example, when ruby (with a refractive index of 1.73) is used as the phosphor, a silica-based adhesive (with an index of approximately 1.5) would suffice. Once the second adhesive has dried, additional coatings may be applied to produce a stronger bond.

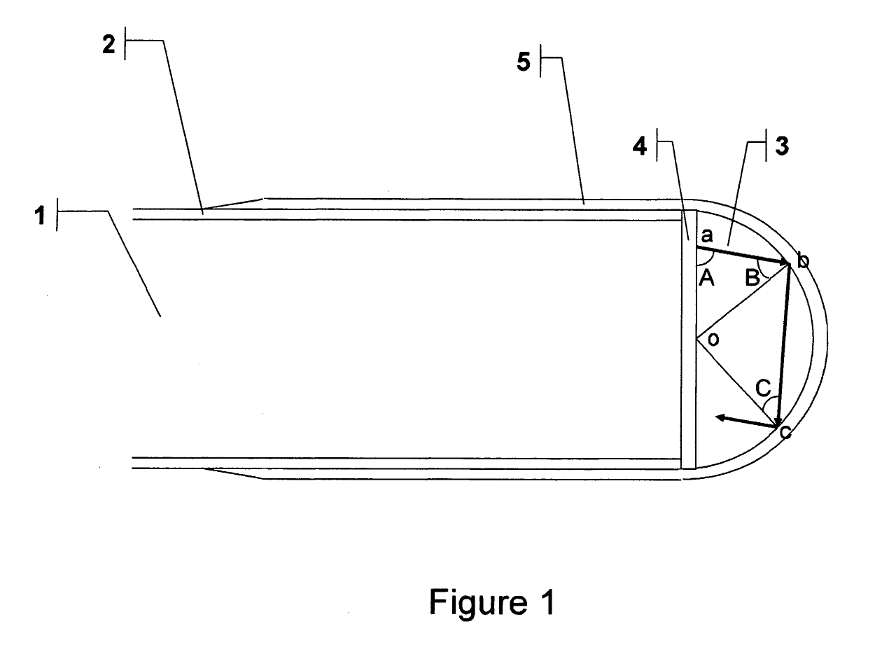

The end portion of a finished probe in which the initial attachment of the phosphor to the fiber is accomplished by using a first adhesive is illustrated in FIG. 1. Hemispherical phosphor 3 is attached to polished end of optical fiber with core 1 and cladding 2 with the use of first adhesive 4. The bonding of the phosphor to the fiber is provided by second adhesive 5, which covers the round part of the hemispherical phosphor as well as a short length of the fiber near the end.

Referring again to FIG. 1, the condition required for the total internal reflection of the excitation light within the hemispherical phosphor can be found by considering a ray incident on the phosphor at the point “a” located a distance h above the center “o”. Suppose this ray impinges on the interface between the phosphor and the second adhesive at the point “b”. Total internal reflection will take place if

n sin B>n′

where n and n′ are the refractive indices of the phosphor and the second adhesive respectively. This condition is equivalent to

nh sin A>n′R

where R is the radius of the hemisphere. Thus, total internal reflection is possible for excitation light rays which enter the phosphor at distances

h>n′R/n

from the center. The reflected ray impinges on the surface of the hemisphere again at point “c”. Since the angle C is equal to angle B, total internal reflection occurs again at “c”. The net result is that the overall distance traversed by the excitation light ray within the phosphor is greatly increased.

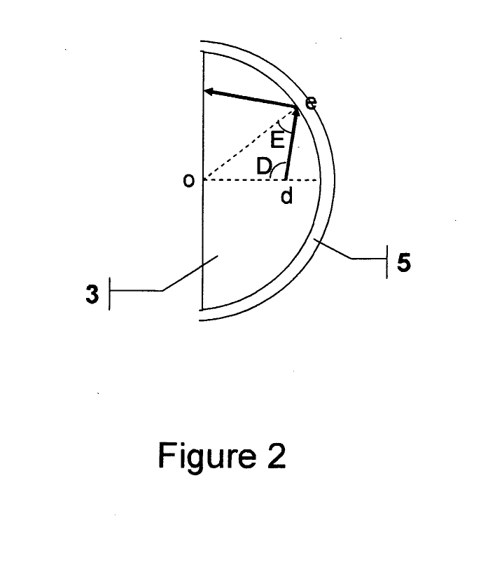

The hemispherical shape of the phosphor also enhances the collection of the emitted fluorescence. FIG. 2 shows how a ray emitted in a generally forward direction can be redirected by total internal reflection into the lead fiber. While this is also possible for a phosphor terminating in a flat surface, the reflected ray will not be guided by the fiber under normal conditions. To be specific, consider a ray emitted by a fluorescer located at the point “d” within hemispherical phosphor 3 on the extension of the fiber axis in a generally forward direction, which ray impinging on the interface between the phosphor and the second adhesive 5 at the point “e”. Total internal reflection will take place if the angle E satifies

sin E>n′/n

### Hence, this can occur for “d” sufficiently close to the tip of the phosphor such that

l>n′R/n

where l is the distance between “o” and “d”. This result can be generalized to fluorescers located elsewhere in the phosphor by considering the intersection between the emitted ray and the extension of the fiber axis, provided they are coplanar.

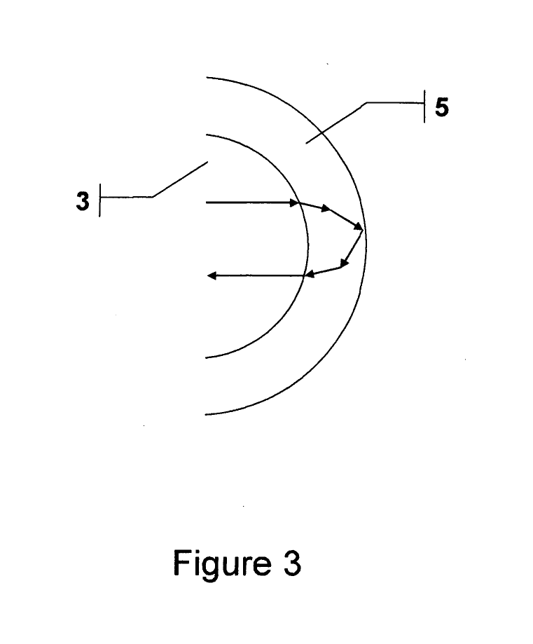

Preferably, the second adhesive is a substantially transparent material with scattering centers dispersed within. Then a light ray propagating in a generally forward direction, after exiting the phosphor, may re-enter as a result of multiple scatterings in the second adhesive. This is illustrated in FIG. 3 in which a light ray originating from hemispherical phosphor 3 is incident on second adhesive 5 and is reflected back after multiple scatterings in the latter. The light ray here may be at either the excitation or fluorescence wavelength. In either case, the net fluorescence power guided back by the lead fiber is increased.

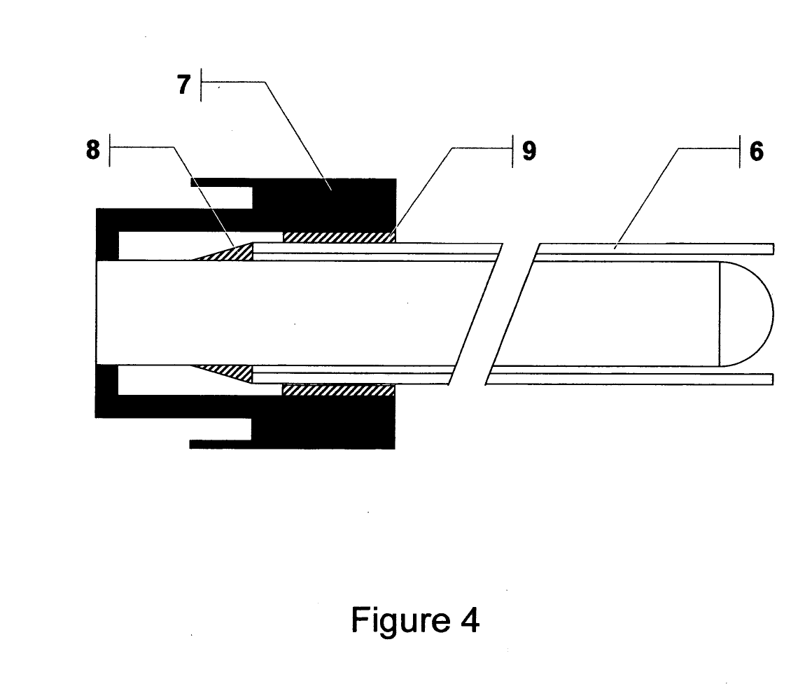

To make the fiber optic probe mechanically more robust, it may be protected by a ceramic tube as shown in FIG. 4. The ceramic tube 6 is attached to the probe near its base with a cement or epoxy 8. Then the assembly is placed in a connector 7 with cement or epoxy 9. The ceramic tube 6 should be as thin as possible, consistent with having a substantially larger shear elastic limit than the fiber itself, in order to keep the thermal mass of the entire probe as low as possible. Also, the ceramic tube should have a low thermal conductivity, in order not to drain heat away from the volume being probed excessively. Alternatively, the fiber optic probe may be put in the connector without any protective sheath to keep both its thermal mass and thermal conductivity at a minimum, albeit this will result in a more fragile sensor. Finally, for sufficiently thin optical fibers, to retain their flexibility, they may be protected by a heat-shrunk tubing with a closed end at the phosphor end of the probe. The other end of the probe will again be fitted in a fiber optic connector.

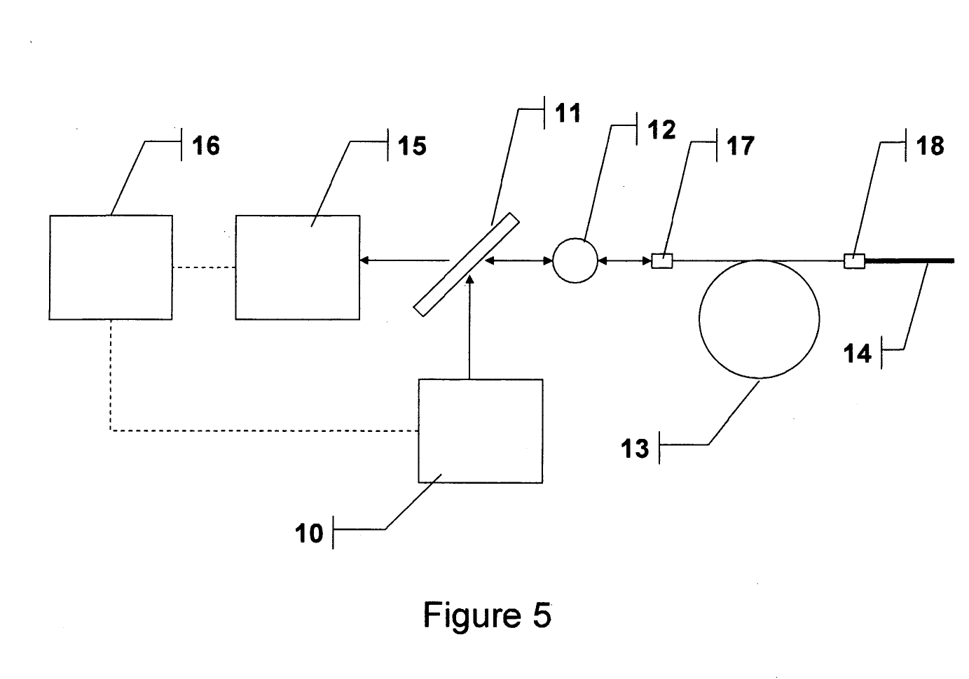

To complete the temperature sensing system, the probe must be connected to an optoelectronic controller-processor. One embodiment of the latter is schematically illustrated in FIG. 5. In this illustration a light emitting diode 10 is used as the excitation source. Upon command from a digital signal processor 16, it emits a series of light pulses. The excitation light is redirected by a dichroic reflector 11 with high reflectivity at the excitation wavelength and high transmission at the fluorescence wavelength onto a ball lens 12, focused onto a fiber optic patch cord 13 terminating in connectors 17 and 18, and guided into the probe 14 with the hemispherical phosphor. Some of the fluorescence produced by the phosphor is guided back into the patch cord, collimated by the ball lens, and directed onto a detector 15 after passing through the dichroic filter 11. In the case of a flexible probe, the use of a patch cord will be optional. The output from the detector is digitized and acquired by the signal processor. The latter calculates the decay time of the fluorescence and converts it to a temperature using a stored functional relationship between the two. The information is then made available to the user via digital output, analog output, or digital display.

It will be seen that the objects set forth above, and those made apparent from the foregoing description, are efficiently attained and, since certain changes may be made in the above construction without departing form the scope of the invention, it is intended that all matters contained in the foregoing description or shown in the accompanying drawings shall be interpreted as illustrative and not a limiting sense.

What is claimed is:

1. A temperature sensing device comprising
(a) a substantially hemispherically shaped phosphor sensing element with both its flat and round surfaces polished and
(b) an optical fiber with both ends polished which guides excitation light to the phosphor sensing element as well as the induced fluorescence away from the phosphor.

2. The device of claim 1 wherein the radius of the hemispherical phosphor is substantially the same as the radius of the optical fiber to which it is attached.

3. The device of claim 1 wherein said polished flat side of the hemispherical phosphor is butted against one of the polished ends of said optical fiber and is held there by an adhesive covering the curved portion of the hemispherical phosphor and a short length of the adjacent fiber.

4. The device of claim 3 wherein the said adhesive has a refractive index smaller than that of the hemispherical phosphor.

5. The device of claim 4 wherein the phosphor is ruby.

6. The device of claim 4 wherein the adhesive is silica-based.

7. The device of claim 3 wherein the end of the optical fiber opposite that with the attached hemispherical phosphor is secured in a fiber optic connector.

8. The device of claim 7 wherein the optical fiber with the attached hemispherical phosphor is protected by a ceramic tube.

9. The device of claim 7 wherein the optical fiber with the attached hemispherical phosphor is protected by a heat-shrunk tubing with a closed end.

10. A temperature measurement system, comprising
(a) the temperature sensing device of claim 1,
(b) a light source which is configured to induce a fluorescence from the hemispherically shaped phosphor of claim 1,
(c) a detector which is configured to receive the temporally resolved fluorescence decay signal from the hemispherically shaped phosphor of claim 1 induced by the said light source, and
(d) an electronic processor which analyzes the output from the said detector and converts it to a temperature reading.
